(19) United States
(12) Patent Application Publication
(10) Pub. No.: US 2015/0227761 A1
(43) Pub. Date: Aug. 13, 2015

(54) SYSTEMS AND METHODS FOR SECURE MESSAGING

(71) Applicant: MADISON CONNECTIONS CORPORATION, Portland, ME (US)

(72) Inventor: Scott A. Cohen, Phoenix, AZ (US)

(21) Appl. No.: 14/619,801

(22) Filed: Feb. 11, 2015

Related U.S. Application Data
(60) Provisional application No. 61/938,470, filed on Feb. 11, 2014.

(51) Int. Cl. G06F 21/64; H04L 12/58

(52) U.S. Cl. CPC G06F 21/64; H04L 51/16

(57) ABSTRACT

Systems and methods for obscuring the existence of a communication system by presenting covert or intentionally deceptive information to a user interface to prevent unintended observers from determining the nature of the communication system. Communications initiated by users of the system are erased less than twenty-five hours after receipt. Notifications, provided to users of the existence of new messages, are likewise erased within a certain period of time after being viewed. Outbound email may be sent as an image and may be configured to be self-erasing upon being read. The systems and methods also provide a safety measure for erasing messages that can be employed by the user at any time. The user can enter a code that is supplied to a server that manages the communications, causing the server to erase all communications and indication of communications, such as logs, for that user.

### STATEMENT REGARDING FEDERALLY SPONSORED RESEARCH OR DEVELOPMENT

(Not Applicable)

### BACKGROUND

Communications that are intended to have reduced observability or heightened security have been implemented in various forms. For example, various types of password protected or encrypted communications have been employed to attempt to reduce access to communications by unintended parties. Often, communications that take place in a commercial setting, using circuit switched or packet switched networks, can be provided with protections for limiting access by unintended parties. However, the existence of such communications is often observable, when messages are sent over a packet switched network, such as the internet, where packet headers can disclose origination and destination addresses. In addition, email applications typically maintain logs of messages, even if such messages are encrypted, so that a “foot print” of a message is observable.

One aspect to obtaining security enhanced communications that is often the focus of the designer of such a communication system is to obscure the existence of such communication. However, such a focus is typically difficult with regard to implementation in commercial networks, since messages are conveyed from an originator, through a third party system to a destination, so that the existence of the message is known to the third party, and also often know to intermediaries or proxies that handle message communication between the origination point and the destination.

Moreover, messaging systems typically store communications on end point devices, or on servers that are accessible by end point devices. Such stored messages can sometimes be vulnerable to exposure or unintended access due to the typically long term storage policies employed by such services.

### SUMMARY

In accordance with the present disclosure, systems and methods are provided to obscure the existence of a communication system by presenting covert or intentionally deceptive information to a user interface to prevent unintended observers from determining the nature of the communication system. In addition, according to some embodiments, all communications initiated by the users of the system are erased less than 25 hours after their receipt. Notifications are provided to users of the existence of new messages, which notifications are likewise erased within a certain period of time, such as 25 hours after being viewed. In some embodiments, outbound email is sent as an image. The outbound image can be configured to be self erasing, so that upon being read, the message erases itself after, for example, 20 minutes. The disclosed systems and methods also provide a safety measure for erasing messages that can be employed by the user at any time. For example, the user can enter a code that is supplied to a server that manages the communications, causing the server to erase all communications and indication of communications, such as logs, for that user.

The inventor of SecureMail.XXX™ Private Email Services (“SecureMail.XXX”) has previous history in the web based email industry as well as network based email as a network engineer and Novell Certified Network Administrator. In 1995 his company acquired a license to an email server (iMail from Ipswitch) which is an integral part of the SecureMail.XXX process. From 1995 to 1997 Madison Connections operated a website Professional Nobodies (www.profnob.com) which offered free, web-hosted email to all-comers; this service was very similar to other startups at the time including Hotmail.com and yahoo.com. The Professional Nobodies website was unregulated for setup: (a) customers would arrive at the website and read marketing materials; (b) they would then convert into a client by enrolling through a webform; (c) enrollment in the @profnob.com email was automatic; (d) the client in the future could access the login directly from mail.profnob.com which bypassed the marketing & enrollment websites. The email server has an application programmer interface (API) and several utilities which the inventor used for regulating aspects of mail sending, maintenance and abuse prevention (e.g. SPAM.)

The intended use of the disclosed systems and methods is to move in the opposite direction of the email industry. We are building a product specifically designed to be short term, low storage, secure and limited. Corollaries in humans have been depicted in popular culture, for example in movies that deal with characters that have anterograde amnesia, a type of acquired amnesia that prevents the creation of short term memories. The presently disclosed systems and methods provide an electronic version of such short term storage messaging: each message lasts for 24 hours and is then deleted; the server resets or deletes the message, which could be email, and the memories are made anew. The product is designed to be discrete with respect to the user's privacy and to obfuscate its use to non-users.

Compared to existing web services the user's information is the user's information. This website may or may not advertise for third parties or itself, and in one embodiment does not provide advertisements. The website may or may not provide pay-per-click or impression based advertising, and may or may not market to its user list and may or may not sell its user list. According to one embodiment, no advertisements or marketing is provided to users, and the user list is not sold. In some exemplary aspects, the disclosed systems and methods represent a private sandbox that is pay-per-user for which access is limited to authenticated users. According to some embodiments, the disclosed systems and methods provide a pure revenue model in which fees are collected from users, and may be collected only from the users.

SecureMail.XXX™ Private Email Services has the following main structures of operation:
Marketing Website—open to general public for education and seeking conversion to customers
Customer Acquisition Website—collects customer data and payment information. Uses PayPal™ or another API enabled service as the merchant processor. Billed periodically and labelled with ‘white’ brand.
Customer WebMail Website—site where customers can access their email.
Mobile Application—Interfaces with the mail services. Has similar features to WebMail Website. Aspiring to ‘white’ icon with ‘white’ greeting screen and password.
Outbound Self Destructing Email Module—Uses GhostMail-like technique of sending message as image which self-destructs 20 minutes after being read.
$1 Million SecureMail.XXX Private Email Services guarantee that email will remain secure if customer follows advice.

In the initial roll out of SecureMail.XXX the users may or may not be allowed to email through the internet to other email servers. In some embodiments, users are not allowed to email through the internet to other email servers. Messages are processed inside the email server, and in some embodiments, are only processed inside the email server. Messages addressed to email addresses offsite may or may not be blocked, and in some embodiments are all blocked. According to some embodiments, a proprietary graphical format is used to encrypt messages for sending offsite, which will cause the message to self-destruct This technique may be used to enable offsite mailing.

Marketing Website

The Marketing Website uses industry standard tools (such as Adobe Dreamweaver) to create hypertext markup language (html) pages (including other formats, style and tools such as but not limited to php, Java, and Flash.) These pages are used the same as typical marketing webpages to educate the potential and existing customers on the availability of SecureMail.XXX products, services, policies and guarantees. In the case of existing customers they can bypass the website by going directly to customer support websites (including forums, technical support and account login.) In the case of prospective customer, they begin the conversion to customers by entering the enrollment portion of the website. The content of all of the webpages are unique and copyrighted by Madison Connections Inc.

Enrollment Website

The enrollment website in addition to the industry standard tools uses secure socket layer (SSL) and other encryption techniques to capture customer's private information. Once the information is captured it is verified using industry standard and proprietary algorithms to determine if the customer is who they purport to be. In the case of the adults only site, the algorithms also determine if the individual is above a certain age.

After the enrollment information is verified, the information is passed into several industry standard databases using custom utility software which incorporates calls into the API within the databases and email server. Some transactions may or may not happen automatically, and in some embodiments most transactions happen automatically. The transactions may or may not be logged for later review (if necessary), and in some embodiments all the transactions are logged (if necessary).

In addition, if a payment is to be made for the service, there is an API which ties into industry standard merchant card processing solutions including PayPal™. When the merchant service name appears on the bill it varies from charge-to-charge making it difficult for persons scrutinizing a charge or bank statement to find a pattern of charges. The user selects from a template of names that will be used during the setup process. We recommend for security purposes that the clients participate in an annual payment program because it minimizes the likelihood that the purchase will be detected. During this enrollment process, the customer may be prompted to set additional account information such as SPAM email addresses.

After enrollment the customer is given immediate access to their webmail account and/or mobile device application access. And as part of the marketing process they are encouraged to invite friends to join the service by entering in the corresponding email addresses. The invitations are sent from the system in standard email html format which contains html code and links to a graphical format message that only displays the marketing information for a specified period of time before self-destructing. For example, the message can be made available for from 1 to 5 days. This graphical information may include both visible and hidden hyperlink connections to the marketing and/or enrollment pages; the hyperlink may be used to track the referral customer so that complimentary use of the server (e.g 1 month per user, up to 1 year for 5 users) may be added onto the referring member's account. When a referral converts, the system sends a message to the user's account and updates the information in the member information database.

Technical Support

The technical support website is available for users who have misplaced their username and/or password. Using data capture forms the system uses industry standard and proprietary algorithms to determine whether the user is enrolled in the system. When it is determined that the user is enrolled in the system the information can be provided to the user on a web interface, sent to a text message or emailed. When email is used the message is sent in a special graphical format that only displays the login information for a specific period of time before self-destructing.

Customer WebMail Access Website

The user can access the website directly or use a link from the marketing website. Once they are at this site they are prompted to enter their username and password. If they have lost this information then they can click through to the technical support website where this information can be retrieved. After their information is validated they enter the WebMail screen which is similar in design to industry standard sites available from outlook.com, Hotmail.com, gmail.com and yahoo.com.

In contrast to industry standard email providers, the SecureMail.XXX email is not enabled to send email messages through the internet to other email providers. The inventor believes that the best way to keep the information secret, safe and secure is to retain it within the ‘sandbox’ of the email server. In addition, according to some embodiments, one user can send an email to another user of SecureMail.XXX by knowing the email address of that user. In some embodiments, the only way a user can send email to another user in the SecureMail.XXX system is to know the email address of that user within the SecureMail.XXX system. In some embodiments, the WebMail interface may or may not include a directory of email addresses of the users. According to some embodiments, there is no directory of email addresses of the SecureMail.XXX users, so there is no methodology to determine specific users of the system without access to the site administrator's dashboard.

The system may provide a proprietary self-destructing graphical email technique to send brief messages offsite. This technique may allow offsite email addresses. As previously described, a user can send a self-destructing marketing email to invite friends to join the service. Another embodiment is to use this same technique to notify a user at their alternative/existing email account that a message is waiting at SecureMail.XXX. A brief message can be sent to a third party that includes a uniform resource locator (URL) link that, upon selection, brings up an encrypted webpage that enables the known-to-the-user contact to send a one time email into SecureMail.XXX.

As part of the self-destructing graphical notification service, the inventor is considering covert methods to inform the user at their third party email address a message is waiting. For example when the user enrolls in the system they could designate a ‘SPAM’ mail email address, subject line and default graphic. The user would then receive this SPAM message in their third party email address whenever a message is awaiting at SecureMail.XXX. The default graphic may use the self-destructing technique which would add further secrecy and security to the communication.

Security may be increased by limiting logins to the system to a limited number of concurrent internet protocol (IP) addresses. The system may or may not use cookies, however, since cookies leave a trail of user activities in the user's internet browser, it would not cookies are preferably not used in some embodiments.

Attachments are possible. The site may restrict the size of attachments. The site may use proprietary utilities to identify users sending certain materials, such as prohibited materials or copyrighted materials (such as RIAA protected items) or certain types of images/video files. The purpose of the attachments capability is to enable users to send private attachments, this website is not intended to be a file-sharing site such as dropbox.com and hightail.com.

One of the key features of the SecureMail.XXX server is the absolute destruction of unflagged email information and logs. At the administrative level of the system only the briefest of information on transactions are logged after they are screened by the utility software; typically this information can include flag status of the user account, the user account identification, destination user account, and date/time stamp. Flags are used in the case of court orders or other legally imposed controls on an account in accordance with government, judicial or other authorities. In the case of flags being active, this portion of the log will be archived beyond the default system destruction timeframe and any emails will also be retained. In unflagged logs and messages, including emails, the message information is by default deleted from the system using commercially available destruction tools in less than 25 hours from the time the message is sent. All messages, including emails, whether sent, received, read, or unread and all logs are deleted within this timeframe. When an unflagged email or log is deleted, the intention is that the data cannot be retrieved or recovered by known, commercially available methods. The inventor is considering allowing users to self-flag email to prevent destruction.

Other methods for authentication at the WebMail login screen are contemplated including rolling code generators such as Two Step Verification available through the Google Authenticator application. An application specific password facility can be provided for IMAP access to the email from email client software. The system has an existing IMAP interface which is modified for the mobile application to prevent hacker penetration of the email system. IMAP is a preferred method for access to SecureMail.XXX when the WebMail client is inaccessible because IMAP stores the information on the server, not in the client application software. IMAP is also useful for providing messages to the user with ephemeral information, e.g., information that is not purposely kept or persistent on the mobile device.

The user can create a contact list within their account. SecureMail.XXX discourages this practices; and we reinforce the discouragement by excluding contact information from coverage in our $1 million privacy guarantee. We recommend that the user consider alternative types of methods for remembering their contacts.

Encrypted Connectivity

The connection between the mobile client as well as any display information will occur over industry standard encryption and security layers.

Easter Egg Connection

An alternate website might be used as the login screen to webmail. The user activates the email website by a combination of keystrokes, clicking at one or multiple points on the screen or by entering a secret code in a box.

Mobile Application

Several mobile applications are being developed for the various devices which are available to consumers for personal and business usage. While the specific rules of each platform vary and the API may be different, stylized techniques and processes can be incorporated to help assure the privacy, secrecy, encryption and security of the user information and messages.

After the application is downloaded from the application store it is installed on the mobile device as a ‘white’ application logo and application name, as illustrated in FIG. 1. Specifically ‘white’ is intended to mean covert or intentionally deceptive to other persons to hide or obscure the application from such other persons that the user wishes. The user may be given the option of choosing which graphical icon/name appears in their display and may be given the opportunity to create a custom icon/name.

During the initial setup the user is prompted for their SecureMail.XXX user name and password, as illustrated in FIG. 2. The application will also collect two personal identification numbers (and possibly an application specific password or two step verification code) (PIN): (a) a rapid access PIN so use of the user name and password is not required; and (b) a duress PIN, as illustrated in FIG. 3. The duress PIN in this application is believed to be unique because it is intended to automatically erase all user messages from the server before the user is allowed access to view messages. The inventor is considering that after the PIN code is entered to error out the application (or crash it) instead of proceeding to the user email retrieval/send screen. The duress PIN code is intended to be used to prevent situations where third parties either directly (e.g. threaten to gain access) or indirectly (e.g. steal device) try to gain access to the user account. The duress PIN code may also be used to erase user logs and/or contacts if the user maintains such on the server. Alternatively, or in addition, the duress PIN code can be configured to be used to direct the user interface to a dummy email account or to other media presentations, such as games or other applications, that serve as a covert or misdirection pretext for user activity.

After the initial setup when the mobile application icon is clicked, the user will arrive at a PIN access screen, as illustrated in FIG. 4. The screen may be a very simple or ‘white’ screen prompting twice for PIN or may be a custom screen (user chooses canned design or custom makes their own) which also prompts twice for PIN. When the user enters the correct PIN twice they are taken to their inbox/sendbox interface, as illustrate in FIG. 5. As described previously, if they enter the duress PIN it erases their email messages and/or logs and/or contacts. The user could also use the duress PIN to intentionally, rapidly erase all of the messages in their inbox. The use of the duress PIN bypasses the system default destruction settings, e.g. erasure less than 25 hours after a message is sent or received. Unless the account was flagged, such as demanded by court order or other governmental or judicial authority, all the emails are deleted irretrievably from the account upon entry of the duress code; the system logs can optionally be deleted in the default time frame. When the email (and any attachment) is flagged to be barred from deletion the system may leave the email visible in the user account or may move the email to a protected location on one of the servers.

The mobile application has basic email client functionalities available, including at least some of those that are available with commercially popular applications such as the gmail mobile application. According to some exemplary embodiments, the inventor intends to not make the mobile client available from a share menu for photos, videos and files; instead the user can opt to originate this activity from within the mobile application. Such a configuration tends to enhance the secrecy or confidentiality of the system by not relying on third party media management. The mobile application is different from a number of communication systems for a number of reasons, including at least those listed here. The mobile application is different from Snapchat because it does not rely upon graphics to communicate between users. The mobile application is different from Confide because it does not use the customer's existing email accounts nor does it partially obscure the screen. It is different from Whisper because it does not show any of the messages anonymously and doesn't use an image macro as the communication medium.

In the background the email client could use the IMAP interface to communicate with the email server; it may use a proprietary format. In any event, we append custom algorithm generated information to the user name and password to prevent direct access by any third party IMAP software. At the email server we employ different proprietary techniques to minimize direct access to the email server including but not restricted to mirroring the data for concurrent access for WebMail and mobile applications. That there are different usernames and passwords is unknown to the user. After the PINs have been entered the first time all user and password information is deleted from the mobile application and replaced with a unique identifier created as part of the obfuscation algorithm. The unique identifier is cross-referenced to the user account information in the user's account maintenance area on the server. The same default server behaviors of automatic deletion of email (except for flags) occurs on the mobile application.

Creating & Purchasing an Account from Mobile Application

The mobile application may be configured to generate an account from the mobile application. Alternatively, or in addition, enrollment and account generation can be implemented through the enrollment website.

Encrypted Connectivity

The connection between the mobile client as well as any display information is provided over industry standard encryption and security layers.

Alternative Access as Easter Egg

The mobile app can appear to be a video game, and may actually be a fully functional game, when downloaded and installed on the mobile app. Either by entering a series of keystrokes, touching one or multiple points on the screen, in a given sequence, or by entering the PIN in a name box, access will be granted to the application and mail data.

Self-Destructive Graphical Email Message

The inventor has previous experience with development and deployment of a service that sent HTML formatted newsletters to email lists (NL Composer by Standard IO.) While using the software the inventor realized that when an embedded image file is download he could track which email reader and which IP address accessed the file; in addition he observed that when the image file was erased a broken link file would appear in any HTML newsletter which contained a link to that file. In recent years a webmail application, ghostmailapp.com, has been developed which incorporates those errors as specific behaviors of its programming.

The self-destructing email will be incorporated through a utility into outbound messages from the SecureMail.XXX server. While the ghostmailapp.com website presents compelling intellectual property, the inventor believes that the limited interface of the ghostmailapp.com which requires a webform and the limited formatting capabilities can be improved upon. To that end the inventor has developed systems and methods that permit a combination of the NL Composer and ghostmailapp.com intellectual property, which enables single, graphical emails that retain original HTML message design (including embedded images), contain a limited degree of optional encryption, link to self-erasing image files and are traceable. Traceablity is used to rapidly expire and/or erase the message once it is received.

As part of the outbound message composition, in addition to the embedded, self-destructive graphic, the message may include a return URL connection that enables the intended message recipient to respond to the outbound email in a similar self-destructing graphic format or as a normal email message from within the ‘sandbox’ at the SecureMail.XXX servers; the outside-to-inside email may be on a different server than the originating outbound email server.

The Guarantee

The inventor has developed a relationship with a Bermuda Monetary Authority insurance company. The company has agreed for a percentage of the gross sale price of each SecureMail.XXX account to offer a money backed guarantee that the message transacted within the SecureMail.XXX private email servers will be erased in the default timeframe or when a duress code is entered. The insurance policy guarantees the integrity of the message from creation until the moment just before delivery for security and secrecy. There is no methodology that exists today (we're working on it) that would prevent a malicious user from taking a screen capture of an image with a digital camera, screen capture software or cut-paste techniques; so once the email is opened the guarantee expires. One of the exceptions to this guarantee is when an account is flagged by authorities for retention; in this case every legal method will be employed to notify the user of the flagging of their account unless prohibited by governmental or judicial authority.

Disclaimers and Agreement

The site utilizes most standard disclaimers plus ones specific to the site operation.

Customer Contact

The site uses customary contact such as web chat, email support and telephone technical support.

Further Comment on Log Deletion

As a user ISP records information, it is believed that under current legislation that the disclosed systems and methods are not required to maintain logs of client usage. Log data may or may not be retained longer than 24 hours on the public marketing site, and in some embodiments, only such log data is retained longer than 24 hours, for example. All other website data on the enrollment, login sites, mobile applications, email messaging, email transmission and email access logs is erased (except as flagged as mandated) at the default period of scheduled destruction. No backup information is retained except for the failsafe protection of the operations of the business.

In accordance with some embodiments of the present disclosure, HTML5 is used to implement the systems and methods described herein. HTML5 provides for interactive multi-media communication and manipulation, so that the covert or intentionally deceptive presentations to a user interface to obscure the existence or purpose of the presently disclosed systems and methods can be relatively easily implemented. For example, a display that pretends to be from a certain innocuous or misdirected source can be provided with functionality that can respond to user input to log into a mail server or website, as is discussed above.

According to some embodiments of the disclosed systems and methods, the user can receive an image that is known to the user to indicate that a message has been received at the server. The image received by the user can appear to be innocuous or related to completely different subject matter than notification of the receipt of a message in the disclosed communication system. Alternatively, or in addition, the user can receive a hypertext link that directs the user to the server upon actuation, and presents the usual login display screen. Such a hyper-text link, or other types of links that can be actuated by the user, can be provided to the user through numerous communication means, including email, text messaging, multi-media messaging websites, or SecureMail.XXX™ originated messages, to name a few examples.

The communication provided by the server in accordance with the present disclosure can be made to be unidentifiable with regard to the originating party. For example, the mail message arrives from the mail server, as an origination point, rather than from the originator of the central message itself. According to one embodiment, the sender or originator of the message is not identified in the message. The user, upon logging into the email account on the server, can view messages sent from the mail server that are presented on the user interface on a temporary basis, and are not necessarily persistent. When email information is transmitted to an endpoint, the typical protocols and conventions do not rely on an uninterrupted connection. Consequently, commands by the user to view messages typically results in a connection access, rather than retrieval of stored data at the endpoint. Thus, message information presented at an endpoint is typically provided on an interface on a temporary, non-permanent basis. This configuration aides in the maintaining the message data impermanent in accordance with the present disclosure.

The presently disclosed systems and methods have advantages over prior communication implementation that use SMTP where an email message passes through a number of SMTP servers from the origination point to the destination point. The SMTP servers typically maintain logs of messages being sent and received, which can act as a footprint for observing the existence and some characteristics of the messages. In contrast, the present disclosure provides two-way isolation of origination information and destination information using a secure mail server. The user of the presently disclosed systems and methods communicates with their account on the server, rather than directly with a destination end point. In addition, message logs may or may not be maintained for the communications involving the secure mail server and in some embodiments are never kept.

In accordance with some embodiments, the identification of the service for secure mail is also obscured or purposely deceptive to avoid an unintended party identifying the service on a bill or invoice, for example. If an unintended party sees a charge for a secure mail service on a credit card bill, the misdirected identification of the service can serve to prevent the unintended party from realizing the existence of the secure mail service.

### BRIEF DESCRIPTION OF THE SEVERAL VIEWS OF THE DRAWINGS

FIG. 1 is an illustration of a “white” application in accordance with an exemplary embodiment of the present disclosure;

FIG. 2 is an illustration of an initial screen in accordance with an exemplary embodiment of the present disclosure;

FIG. 3 is an illustration of a second initial screen in accordance with an exemplary embodiment of the present disclosure;

FIG. 4 is an illustration of a login screen in accordance with an exemplary embodiment of the present disclosure;

FIG. 5 is an illustration of an application screen in accordance with an exemplary embodiment of the present disclosure;

FIG. 6 is an illustration that includes a block diagram of system organization in accordance with an exemplary embodiment of the present disclosure; and

FIG. 7 is an illustration of the logical organization of the system in accordance with an exemplary embodiment of the present disclosure.

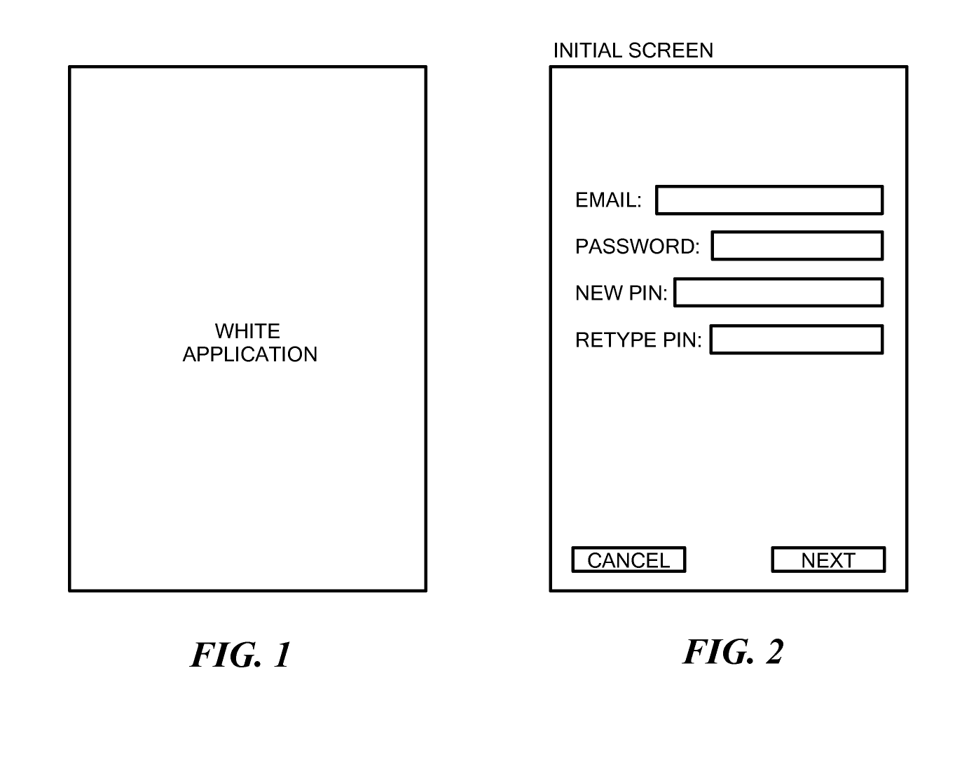

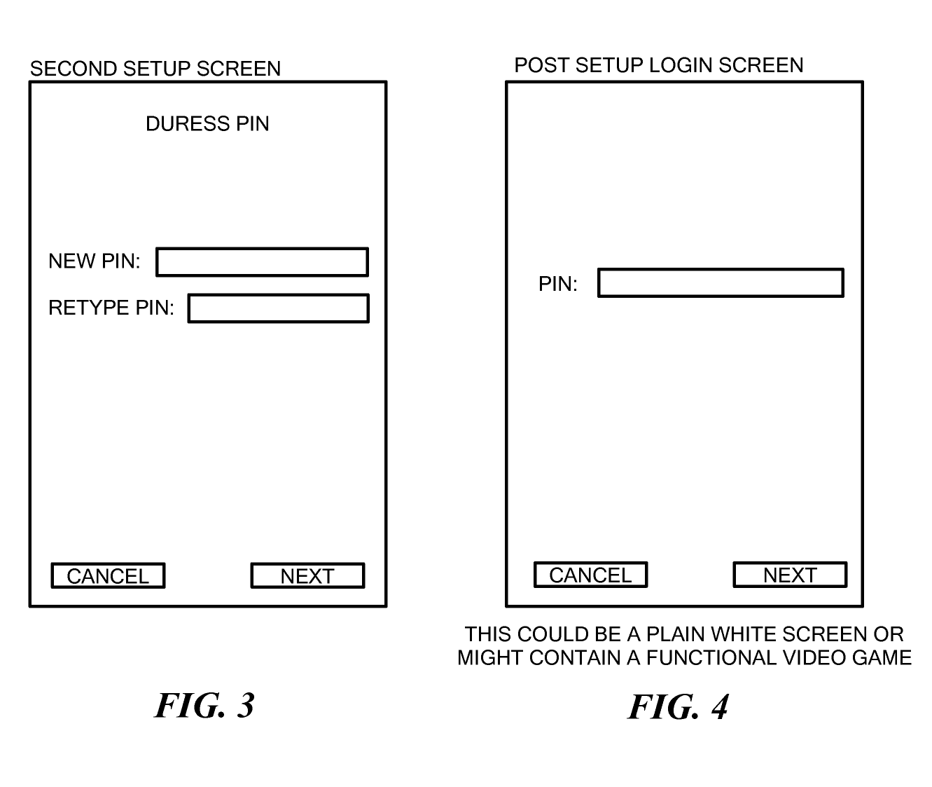

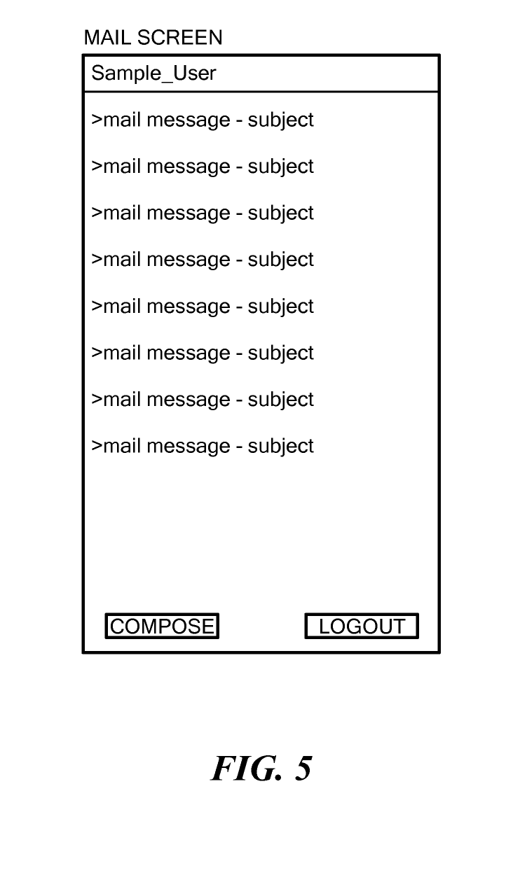

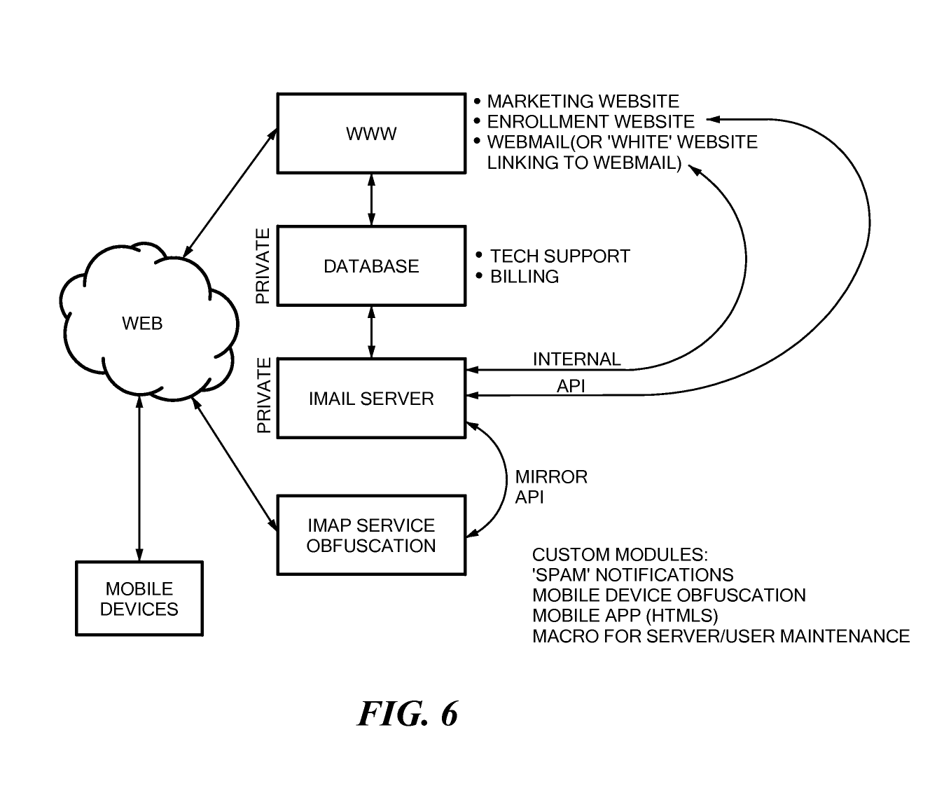

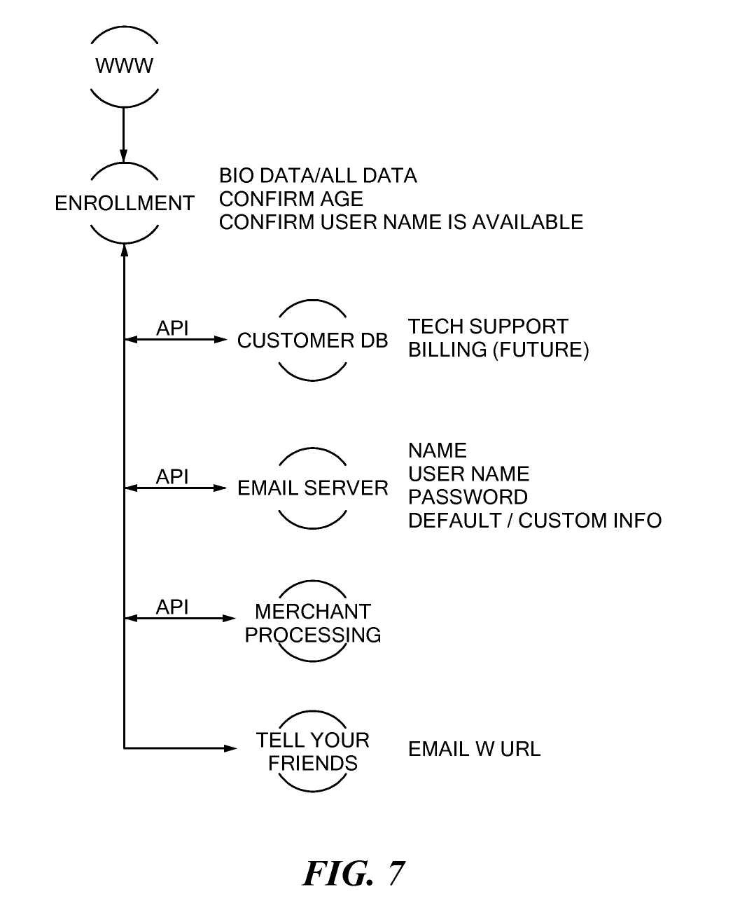

### DETAILED DESCRIPTION OF THE INVENTION

The operations herein depicted and/or described herein are purely exemplary and imply no particular order. Further, the operations can be used in any sequence when appropriate and can be partially used. With the above embodiments in mind, it should be understood that they can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations depicted and/or described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed systems and methods can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

The foregoing description has been directed to particular embodiments of this disclosure. It will be apparent, however, that other variations and modifications may be made to the described embodiments, with the attainment of some or all of their advantages. The procedures, processes and/or modules described herein may be implemented in hardware, software, embodied as a computer-readable medium having program instructions, firmware, or a combination thereof. For example, the function described herein may be performed by a processor executing program instructions out of a memory or other storage device. Therefore, it is the object of the appended claims to cover all such variations and modifications as come within the true spirit and scope of the disclosure.

What is claimed is:

1. A system for providing secure communications, comprising:
a processor communicatively coupled to a memory to access and execute instructions to:
receive a user input to establish a communication account specific to a user;
receive a code associated with the account that represents an indication for erasing all messages and logs for the account;
store the code in association with the account;
receive an active code;
compare the code with the active code; and
upon determining a match between the code and the active code, erase all messages and logs associated with the user account.

2. A method implemented on a processor communicatively coupled to a memory to permit access and execution of instructions to provide secure communications, the method comprising:
receiving a user input to establish a communication account specific to a user;
receiving a code associated with the account that represents an indication for erasing all messages and logs for the account;
storing the code in association with the account;
receiving an active code;
comparing the code with the active code; and
upon determining a match between the code and the active code, erasing all messages and logs associated with the user account.

3. A communication device for use in implementing secure communications, comprising:
a processor communicatively coupled to a memory for accessing and executing instructions from the memory to:
receive a preselected indication of a new message being available at a connected server, the message being purposely misdescriptive of the communication;
receive a user input action to access the server to view the message; and
determine when the message has been viewed and erase the message less than 25 hours from the time when the message was viewed.

4. A method implemented on a processor communicatively coupled to a memory to permit access and execution of instructions to provide secure communications, the method comprising:
receiving a preselected indication of a new message being available at a connected server, the message being purposely misdescriptive of the communication;
receiving a user input action to access the server to view the message; and
determining when the message has been viewed and erase the message less than 25 hours from the time when the message was viewed.
